(19) United States
(12) Patent Application Publication
(10) Pub. No.: US 2024/0207130 A1
(43) Pub. Date: Jun. 27, 2024

(54) SYSTEM AND METHOD FOR LIMB COMPRESSION

(71) Applicants: Benjamin POCOCK, Landenberg, PA (US); Céderick LANDRY, Landenberg, PA (US); Sean D. PETERSON, Landenberg, PA (US); Roger TSANG, Landenberg, PA (US); PRESSION LLC, Landenberg, PA (US)

(72) Inventors: Benjamin POCOCK, Landenberg, PA (US); Céderick LANDRY, Landenberg, PA (US); Sean D. PETERSON, Landenberg, PA (US); Roger TSANG, Landenberg, PA (US)

(73) Assignee: PRESSION LLC, Landenberg, PA (US)

(21) Appl. No.: 18/559,089

(22) PCT Filed: Mar. 24, 2022
(86) PCT No.: PCT/US2022/021781

§ 371 Date: Nov. 6, 2023

Related U.S. Application Data
(60) Provisional application No. 63/165,366, filed on Mar. 24, 2021.

(51) Int. Cl. A61H 11/00

(52) U.S. Cl. CPC A61H 11/00; A61H 2201/0173; A61H 2201/1223; A61H 2201/1642; A61H 2201/165; A61H 2201/1664; A61H 2201/5007; A61H 2201/5071; A61H 2209/00; A61H 2230/045; A61H 2230/255

(57) ABSTRACT

A system for applying external compression to a limb of a user via a system of actuated barrels with compression elements. The system may include a motor, a brake configured to selectively restrict the rotation of different barrels, and a controller configured to operate the brake and motor at different periods of time during use. Sensors may be included, which are coupled to a controller, which, based on sensor data, dictates the timing and degree of compression by controlling the braking system and applied motor current.

### FIELD OF THE INVENTION

Embodiments of the present disclosure are directed to systems and methods for limb compression.

### BACKGROUND

The vasculature in the body includes veins which have one-way valves to prevent a backflow of blood. In the lower extremities, extra work is required to move blood against gravity to the input side (right atrium) of the heart. The skeletal muscles assist the heart during perambulatory motion by compressing veins in the lower extremities, aiding in emptying the venous circulation and therefore provide assistance in returning blood back to the heart against gravity. The skeletal muscles of the calf have been identified as supporting this function. This process, namely, contraction of the muscles and resulting peristaltic blood flow in the lower extremities is generally known as the skeletal muscle pump, or the second heart effect. The skeletal muscle pump is essential for maintaining adequate venous and interstitial fluid flows in the body.

The human muscle pump prevents venous pooling in the leg through mechanical actuation of muscle contraction constricting the veins and tissues, thus promoting limb circulation. The absence of sufficient limb circulation puts the individual at risk of clot formation, which provides a significant health risk. Active mechanical limb compression has been shown to promote circulation in the limb similar to that generated by the muscle pump. Reduction in venous stasis reduces the risk of clot formation, while increased limb blood flow also aids in removal of metabolites generated during exercise.

### SUMMARY

An embodiment of the present disclosure is a system comprising an actuation module. The actuation module has a motor, a motor barrel coupled to the motor and is rotatable about a longitudinal axis, and a secondary barrel that is rotatable about the longitudinal axis, and a brake coupled to the motor barrel and the secondary barrel. The system includes a first compression element coupled to the motor barrel and configured to apply compression to a limb when placed around the limb when the motor barrel is rotating, and a second compression element coupled to the secondary barrel and configured to apply compression to a limb when placed around the limb when the second barrel is rotating. The system also includes a controller operably coupled to the motor and the brake, the controller configured to, in response to one or more inputs, in a first operating condition, cause the motor to rotate the motor barrel and the secondary barrel, and in a second operating condition, cause the brake to inhibit rotation of the secondary barrel while permitting the motor barrel to rotate independently of the secondary barrel.

An embodiment of the present disclosure is a system comprising an actuation module. The actuation module may include a motor and a shaft that extends along a longitudinal axis and is coupled to the motor. The shaft is configured to rotate about the longitudinal axis in response to operation of the motor. The actuation module also includes a motor barrel coupled to the shaft such that the motor barrel is rotatable about the longitudinal axis, and a secondary barrel coupled to the shaft such that the secondary barrel is rotatable about the longitudinal axis. A brake may be coupled to the motor barrel and the secondary barrel. The system further includes a first compression element coupled to the motor barrel and configured to apply compression to a limb when placed around the limb and a second compression element coupled to the secondary barrel and configured to apply compression to a limb when placed around the limb. The system includes a controller operably coupled to the motor and the brake. The controller configured to, in response to one or more inputs, in a first operating condition, cause the motor to rotate the motor barrel and the secondary barrel, and in a second operating condition, cause the brake to inhibit rotation of the secondary barrel while permitting the motor barrel to rotate independently of the secondary barrel.

Another embodiment of the present disclosure includes a system comprising an actuation module. The system also includes a first compression element coupled to the actuation module and configured to apply compression to a limb when placed around the limb, and a second compression element coupled to the actuation module and configured to apply compression to the limb when placed around the limb. The system further includes at least one sensor configured to measure pressure applied by the first and second compression elements to a limb, and a controller operably coupled to the at least one sensor and the actuation module. The controller is configured to, in response to data obtained by the at least one sensor, automatically cause the first and second compression elements to apply compression to the limb up to a predetermined threshold of pressure. Such a system may be used so that the system works properly without the user needing to make adjustments after placing it on the limb.

According to the embodiment described herein, the system includes a housing that carries the actuation module.

According to an embodiment, the first compression element is a first strap coupled to the motor barrel, the first strap having a first end and a second end opposite the first end; and the second compression element is a second strap coupled to the secondary barrel, the second strap having a first end and a second end opposite the first end.

According to another embodiment, the first strap is configured to wind around the motor barrel such that rotation of the motor barrel pulls the first end of the first strap while the second end of the first strap remains fixed and shortens the first strap around the limb.

According to another embodiment, the first end and the second end of the first strap is coupled to the motor barrel such that rotation of the motor barrel causes the first strap to wind around the motor barrel.

According to an embodiment, the system includes a plurality of sensors configured to measure a rate of blood flow in the limb. The controller is communicatively coupled to the plurality of sensors such that the controller causes transition between first and second operating conditions based on measured rate of blood flow in the limb.

According to an embodiment, the plurality of sensors includes at least one physiological sensor and at least one pressure sensor. In such an embodiment, the physiological sensor is configured to take real-time measurements of systolic and diastolic time delay and pulse wave delay at the limb. In such an embodiment, the physiological sensor is a non-invasive peripheral blood flow sensor or an optical sensor. In such an embodiment, the pressure sensor is configured to take real-time and continuous measurements of the amount of pressure applied by the first and second compression elements.

According to an embodiment, the controller is further configured to analyze a blood flow pattern and modify the timing and compression levels applied by the actuation module. The controller may include at least one processor, a memory unit, and a communications unit.

According to another embodiment of the present disclosure, a method includes automatically tightening a compression element on a limb may be implemented. The method includes causing a first compression element and a second compression element to automatically apply compression to a limb of a user. The method includes measuring a pressure applied by each of the first and second compression elements to the limb of the use. The method further includes, causing, via a controller, the first and second compression elements to stop applying compression to the limb of the user when the pressure applied by each of the first and second compression elements reaches a predetermined threshold.

Another embodiment of the present disclosure is a method that includes compressing a first portion of a limb of user with a first compression element coupled to a motor barrel by causing the motor barrel to rotate about an axis. The method includes starting compression of a second portion of the limb of user with a second compression element coupled to a secondary barrel by causing the secondary barrel to rotate about the axis while the first compression element compresses the first portion of the limb. The method also includes applying a brake to the motor barrel to inhibit its rotation so that the first compression element no longer compresses the first portion of the limb. The method also includes continuing compression of the second portion of the limb of user with the second compression element coupled to the secondary barrel by continuing rotation of the secondary barrel about the axis. The method also includes applying the brake to the secondary barrel to inhibit its rotation so that the second compression element no longer compresses the second portion of the limb.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 is a block diagram of a limb compression system according to an embodiment of the present disclosure;

FIG. 2 is a perspective view of the limb compression system shown in FIG. 1;

FIG. 3A is a side view of a barrel and the first compression element of the limb compression system shown in FIG. 2;

FIG. 3B is a side view of a barrel and the first compression element of the limb compression system shown in FIG. 2 having an alternate strapping configuration;

FIG. 4 is a top view of the limb compression system shown in FIG. 2;

FIG. 5 is a side view of the limb compression system shown in FIG. 2;

FIG. 6 is a bottom perspective view of the limb compression system shown in FIG. 2;

FIG. 7 is a perspective view of the limb compression system shown in FIG. 2, with the first compression element and the second compression element removed;

FIG. 8 is a cross section of the actuation module of the limb compression system taken along line A-A in FIG. 2;

FIG. 9 is a block diagram of the limb compression system shown in FIG. 2;

FIG. 10 is a flowchart of a method of limb compression according to an embodiment of the present disclosure;

FIG. 11A is a graph depicting results of applied pressure of a limb compression system over an application cycle; and

FIG. 11B is a graph depicting results of applied pressure of a limb compression system over an application cycle at a specified location.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods.

In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

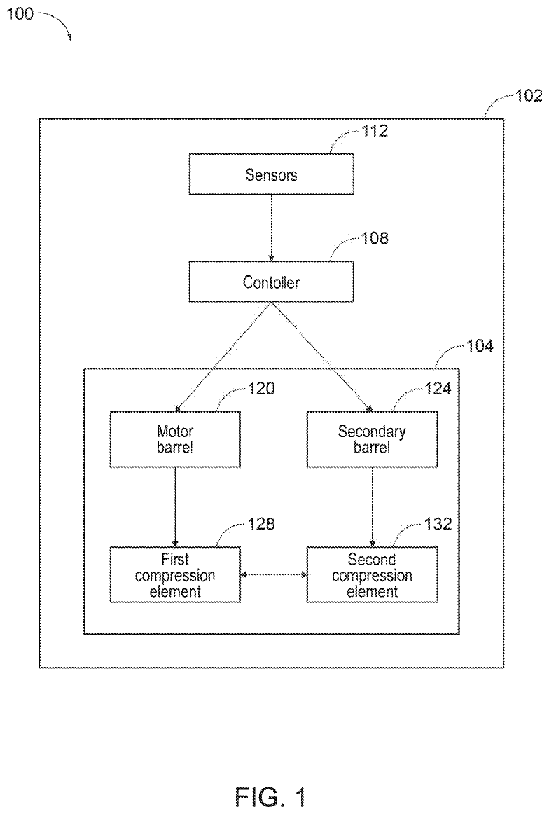

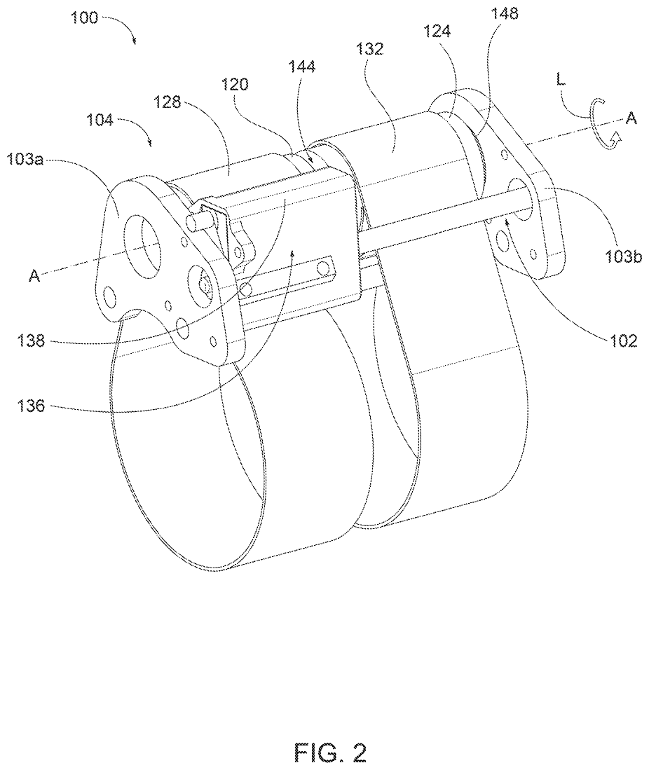

Embodiments herein relate to a system for applying sequential compression to a limb with controllable timing and level of compression using one or more common actuation units. Referring to FIGS. 1-2, the system 100 comprises an actuation module 104, a controller 108 operably coupled to the actuation module, and one or more sensors 112. The actuation module 104 includes a motor barrel 120 rotatable about a longitudinal axis L and operably coupled to the controller 108, a secondary barrel 124 that is rotatable about the longitudinal axis L and operably coupled to the controller 108, a first compression element 128 coupled to the motor barrel 120, and a second compression element 132 coupled to the secondary barrel 124. The motor barrel 120 is coupled to a first shaft 144 such that the motor barrel is rotatable about the longitudinal axis L. The secondary barrel 124 is also coupled to the first shaft 144 such that the secondary barrel is rotatable about the longitudinal axis L.

In the illustrated embodiment, the system 100 includes one actuation module. In alternative embodiments, the system 100 may include additional actuation modules 160 that are linked together along the longitudinal axis L. The system 100 also includes a housing structure 102 that supports the elements of the system 100. The system is configured to, in response to one or more inputs, in a first operating condition, cause the motor barrel 120 and the secondary barrel 124 to rotate, and in a second operating condition, inhibit rotation of the secondary barrel 124 while permitting the motor barrel 120 to rotate independently of the secondary barrel 124.

The first compression element 128 is coupled to the motor barrel 120 and configured to apply compression to a limb when placed around the limb when the motor barrel 120 is rotating. The second compression element 132 is coupled to the secondary barrel 124 and configured to apply compression to a limb when placed around the limb when the secondary barrel 124 is rotating. In the illustrated embodiment, the first and second compression elements 128, 132 may be straps, formed into respective loops. The dimensions of the straps are such that the straps can wrap around the first and second compression elements 128, 132, respectively, and also such that the loops fit around the limb of the user. Actuation of the motor barrel 120 and the secondary barrel 124 causes the barrels 120, 124 to rotate about the longitudinal axis L, which winds the first and second compression elements 128, 132 further around the motor barrel 120 and the secondary barrel 124, causing the straps to shorten and apply pressure to the limb.

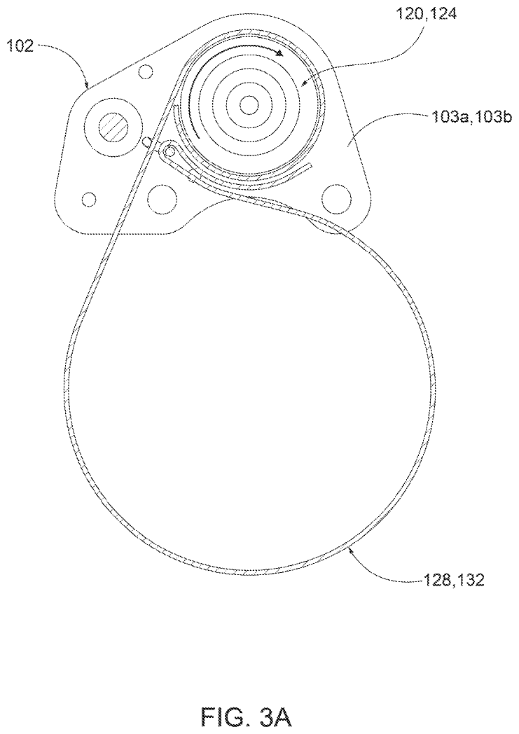

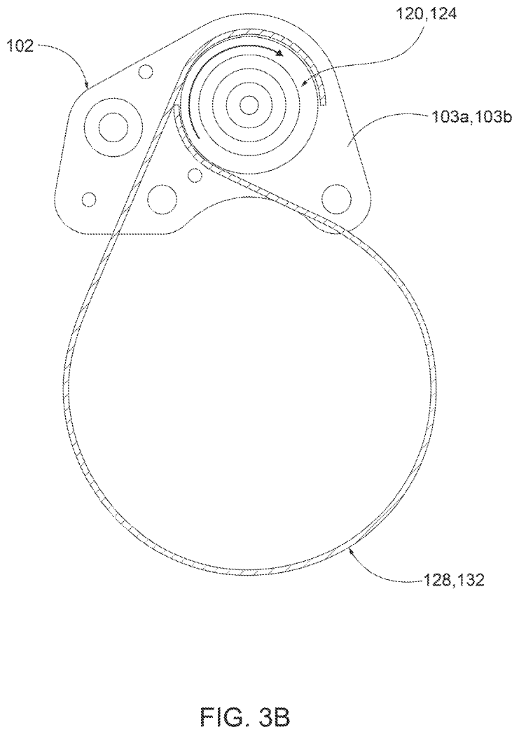

Referring to FIG. 3A, in the illustrated embodiment, the first compression element 128 and the second compression element 132 are configured to wind around the barrels 120, 124, respectively. The strapping may be wound around the barrels 120, 124 such that when the barrels 120, 124 turn, one side of the first and second compression elements 128, 132 is pulled with the other side fixed. Thus, force is applied to one end of the first and second compression elements 128, 132, around the leg. The loop circumference is governed by the degree of rotation of the motor barrel 120. The pressure applied is proportional to the motor torque applied. Referring to FIG. 3B, in another embodiment, the first compression element 128 and the second compression element 132 are configured to wind around the barrels 120, 124, such that rotation of the barrels 120, 124 pulls on both ends of the first compression element 128 and the second compression element 132, winding more of it onto the barrels 120, 124, and thereby shortening the loop around the limb and applying a pressure to the limb.

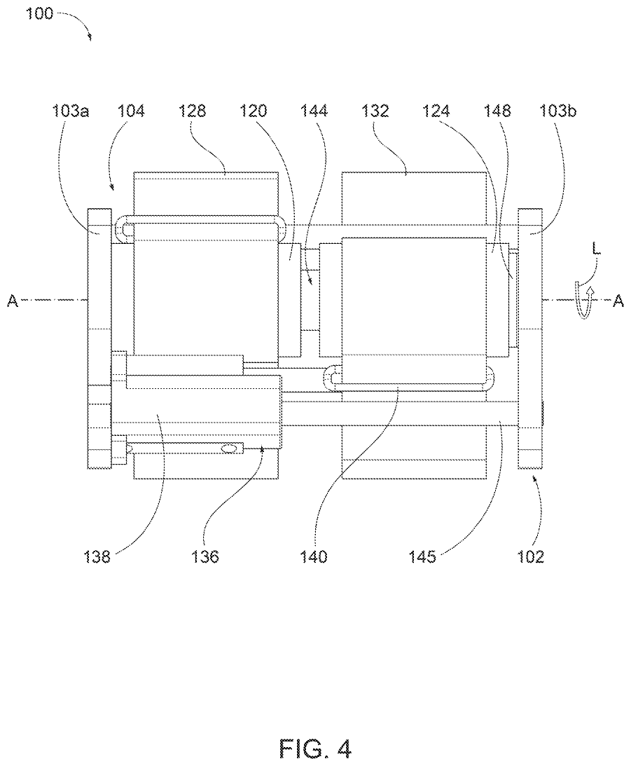

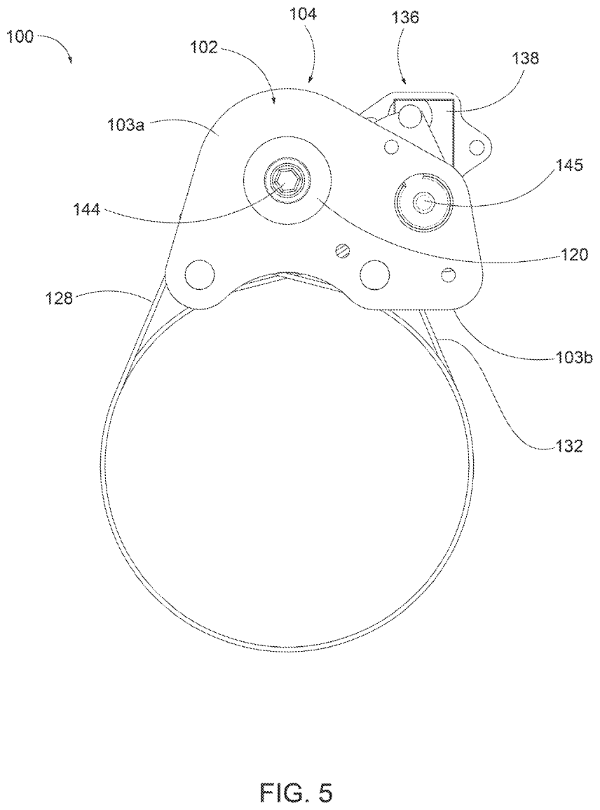

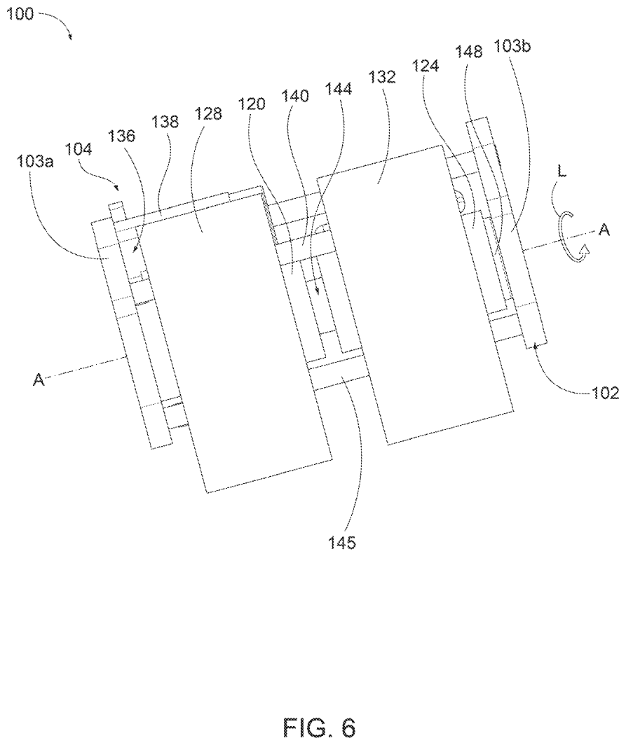

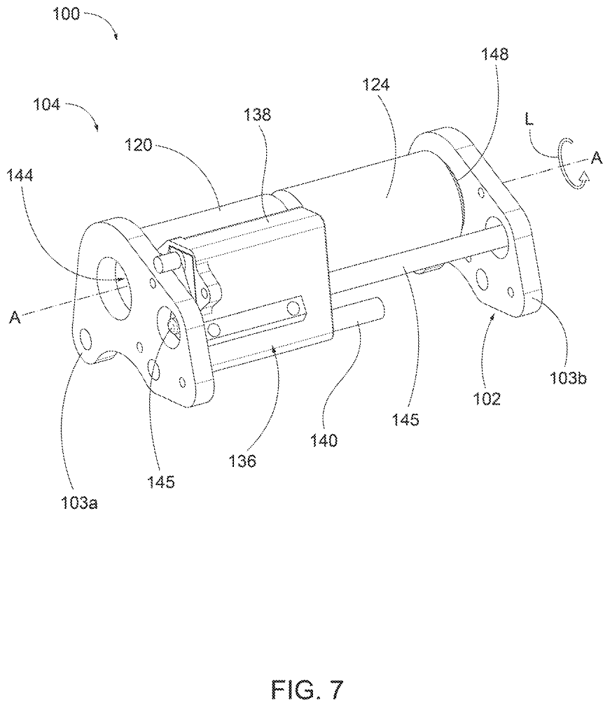

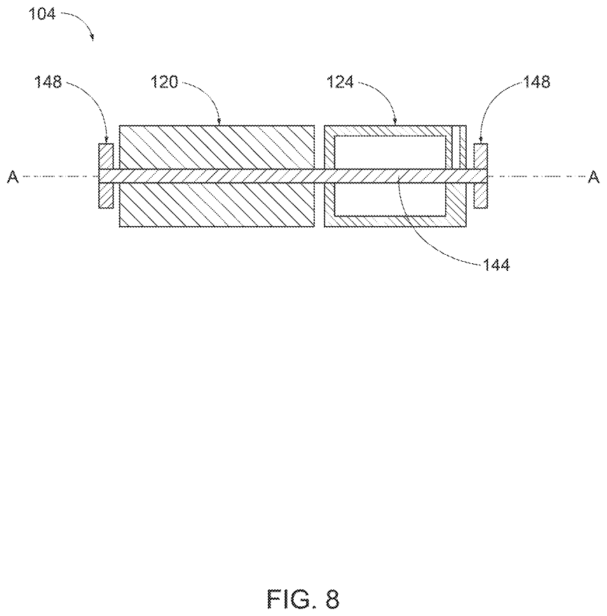

Continuing with FIGS. 4-8B, the motor barrel 120 is mounted to a frame 103a of the housing 102 via the first shaft 144. The motor barrel 120 is driven by a motor 136 which rotates the first shaft 144 and the motor barrel 120. In the illustrated embodiment, the motor 136 is an electric motor. In alternative embodiments, various types of motors may be utilized. The motor 136 is mounted between the frames 103a, 103b, parallel to the longitudinal axis L along a second shaft 145. The motor 136 is encased in a motor housing 138. When the motor 136 is activated, equal and opposite torque is applied to the motor barrel 120, via the motor housing 138, and the secondary barrel 124, via the first shaft 144. In the illustrated embodiment, the motor barrel 120 is cylindrical in shape and includes a lumen sized for the first shaft 144 to pass through. The motor barrel 120 is further sized and shaped to allow the first compression element 128 to be wrapped around the motor barrel 120.

The secondary barrel 124 is mounted to a portion of the housing 102 opposite from the motor barrel 120 along the longitudinal axis L. In the illustrated embodiment, the motor barrel 120 is cylindrical in shape and includes a lumen sized for the first shaft 144 to pass through. The motor barrel 120 is further sized and shaped to allow the second compression element 132 to be wrapped around the secondary barrel 124. The motor barrel 120 may be referred to as the first barrel and the secondary barrel 124 may be referred to as the second barrel. In the illustrated embodiment, the barrels 120, 124 are arranged in-line along the same longitudinal axis L connected by the first shaft 144 and supported by bearings 148.

The secondary barrel 124 is coupled to the motor barrel 120 via the first shaft 144. The first shaft 144 is operably coupled to a braking system 140. The braking system 140 may comprise a strap system that winds around a barrel, which is tightened by the motor 136, enclosed in the housing 102. The braking system 140 is configured to hold the motor barrel 120 so that only the secondary barrel 124 rotates when a certain condition is met. When the braking system 140 is released, the motor barrel 120 counter rotates and is held by the second compression element 132 on the secondary barrel 124. Application of the braking system 140 locks the secondary barrel 124 to the housing 102, allowing the motor barrel 120 to rotate independently of the secondary barrel 124, thereby applying pressure to the limb via the strap attached to the motor barrel 120. When the braking system 140 is released, the secondary barrel 124 rotates, pushing off the already activated motor barrel 120. This sequence results in peristaltic compression of the limb. The change in strap length is driven by the degree of rotation of the barrel and the pressure applied is determined by the motor torque; strap length and applied pressure are coupled by the motor power.

The present disclosure includes multiple embodiments of coupling mechanisms which selectively connect and disconnect two rotating barrels. Below is a set of example mechanisms which represent some, but not all of the possible embodiments. In one example, a coupling mechanism is a clutch. A clutch is a mechanical device that engages and disengages power from a driving body to a driven body. The drive and driven bodies can take on multiple physical representations including, but not limited to: shafts, barrels, rods, and surfaces. In one embodiment, a clutch selectively engages and disengages a rotatable assembly with a rotating drive shaft. The engagement can be made to either completely couple the driving shaft to the rotatable assembly, completely decouple the driving shaft from the rotatable assembly or a varied level of coupling. In one example, the coupling mechanisms is a brake, which controls the application of friction between two surfaces. Friction can be applied in many forms, including but not limited to physical contact between two surfaces, fluid viscosity, and electromagnetic force. In one embodiment, an electromagnetic motor body is rigidly coupled to a driven surface and the electromagnetic motor's drive shaft is rigidly connected to a driving surface. When the electromagnetic motor is run in reverse, the mechanical energy of the driving system is converted into electrical energy. Resistance to the flow of this electrical energy causes mechanical resistance to motion of the driving shaft. This resistance creates a coupling action which causes the motor body to rotate in proportion with the driving shaft. In another example, an electromagnetic coupling may be used. An electromagnetic coupling is a non-contact device which transfers torque between two moving surfaces. In one embodiment, an electromagnetic coupling consists of a driving shaft which is driven by a motor and a driven shaft which is rigidly connected to a rotatable body. The electromagnetic coupling can be selectively coupled and decoupled from the driving shaft to control when torque is and is not transferred between the two shafts.

The sensors 112 are used to obtain data to aid in controlling operations of the system. For example, one or more sensors 112 obtains data indicative of the applied pressure to the limb and relevant physiological signals. The applied pressure and physiological signals are used via control software in the controller 108 or a separate computing device to help control compression timing. The controller 108, as described above, is configured to coordinate activation of the motor 136 and timing of the braking system 140 based upon sensor inputs and desired compression level and timing. In one embodiment, the system 100 is modular, with one motor barrel 120 and secondary barrel 124 comprising an actuation module 104. In another embodiment, the system 100 may include multiple actuation modules 104 that may be controlled by the same controller 108.

The system 100 is also designed to auto-tighten on the user's limb. Upon first installation, the first compression element 128, and the second compression element 132 are automatically wound around the barrels 120, 124 to set the system 100 in the operating condition. More specifically, in one embodiment, at least one sensor 112 is configured to measure pressure applied by the first and second compression elements 128, 132 to the limb. The controller 108, which is operably coupled to the at least one sensor 112 and the actuation module 104, is configured to, in response to data obtained by the at least one sensor 112, automatically cause the first and second compression elements 128, 132 to apply compression to the limb up to a predetermined threshold of pressure. In use, prior to operation, the system 100 is placed around the limb. The system 100 is then activated, and subsequently goes through one actuation cycle, as discussed herein, which automatically tightens the first and second compression elements 128, 132 to the limb, readying the device for use. During the auto-tightening phase, the first and second compression elements 128, 132 start to loosen, allowing the motor 136 to spin freely and wind up the slack in the first and second compression elements 128, 132 until such time as the first and second compression elements 128, 132 tighten sufficiently to increase resistance on the motor 136. Such a system may be used so that the system works properly without the user needing to make adjustments after placing it on the limb.

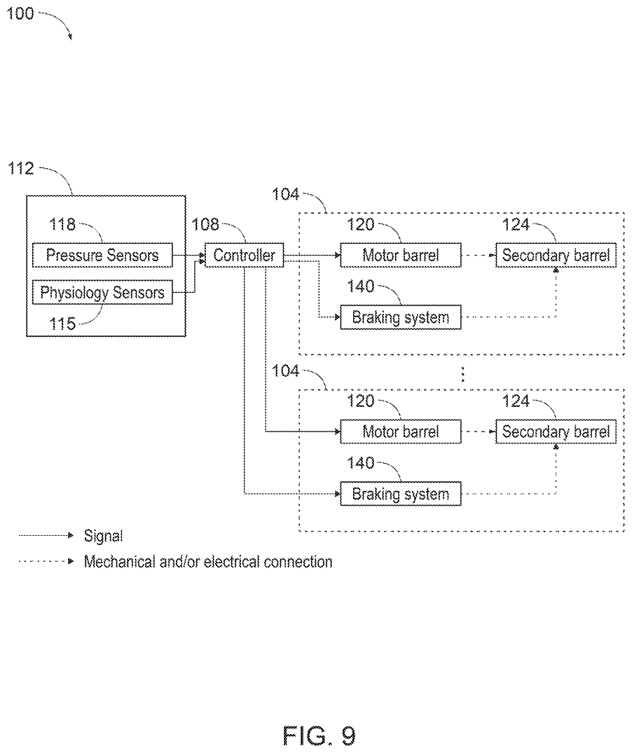

Referring to FIG. 9, the system 100 may comprise a plurality of sensors 112 that provide user and operational data to the controller 108 that controls compression timing and pressure levels applied by the actuation module 104. In the illustrated embodiment, each actuation module 104 comprises the motor barrel 120, the braking system 140, and the secondary barrel 124. Wound around each barrel 120, 124 is, for example, the strap 128, 132, that forms a loop around the limb. The limb may be a leg, such as a lower leg (beneath a knee of the user), but limb application can include an arm depending on the desired area of use/treatment. The system 100 may be a part of a wearable sleeve, or garment, which is configured to be worn, or fit around the limb. A non-limiting example of an amount of compression may be approximately 20-160 mmHg wherein “approximately” is used to mean plus or minus 10.

In one example, the timing and degree of compression applied by the compression apparatus may be dictated by signal feedback from physiological sensors 115 and pressure sensors 118, respectively. The use of rapid response actuation allows for actuation of the compression elements 128, 132 to occur fast enough to apply compression within a fraction of one cardiac cycle and repeat compression during each cardiac cycle or a subset of heartbeats. In another example, however, the data may be derived or obtained from different sources other than the sensors 112. For example, pressure and rate may change based on activity level. Thus, a strict signal feedback loop may not be required because, a user may not need the same amount of supplementation for different activity levels. Furthermore, this could save power and increase battery life. Thus, the feedback loop may be a mechanism to modify compression sequence and timing based on one or different activity levels. In the illustrated embodiment, the different activity levels are controlled via the controller 108. In alternative embodiments, the different activity levels are controlled via a separate computing device as needed.

In one example, the physiological sensors 115 are configured to obtain data indicative of the current state of blood flow during the whole cardiac cycle. More specifically, the physiological sensors 115 are configured to obtain data indicative of the local diastole. In such an example, the physiological sensors 115 may be one or more non-invasive peripheral blood flow sensors such as, but not limited to, a pulse photoplethysmograph (“PPG”), or another optical sensor. Peripheral blood flow pattern of the user may be used to set and modify the compression timing set by the controller 180 and makes the system 100 customizable to the anatomy and physiology (such, as, but not limited to, vascular system) of the user. This measurement may provide for directly measuring arrival of the arterial pulse wave at the limb, which is delayed relative to the timing of the cardiac contraction given by measurements of heart rate from an electrocardiogram (ECG). Such delay may be due to height, physical condition, user body orientation, or heretical features of the user. Thus, the pulse wave delay relative to the timing of the cardiac contraction varies between individuals and further emphasizes the importance of measuring local blood flow at the limb.

The pressure sensors 118 may be provided to measure compression to ensure that an identified amount of pressure is actually being applied. Additional sensors 112 under each strap may be taking real-time, continuous readings of applied pressure, which is read by the controller 108 to control motor torque in the motor barrel 120 in a feedback loop.

The controller 108 may be any device configured to process, store, and send/receive information used to implement software that controls the system as described herein. The controller 108 may include one or more processors, a memory, and an input/output portion. In some instance, the controller 108 may include an optional user interface (UI) 28. The processor, memory, and input/output portion can be coupled together to allow communications therebetween and can interface with the software application. The software application may include an application programmatic interface (API). The memory can be volatile (such as some types of RAM), non-volatile (such as ROM, flash memory, etc.), or a combination thereof, depending upon the exact configuration and type of processor. The controller 108 may include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic storage or other magnetic storage devices, universal serial bus (USB) compatible memory, or any other medium which can be used to store information and which can be accessed by the controller.

As illustrated herein, the controller 108 may be any particular hardware device and its components, examples of which include a portable computing device, such as a laptop, tablet or smart phone, or other computing devices, such as a desktop computing device or a server-computing device, or any computing device or controller. While the term “controller” is used, it should be appreciated that a computing device may also be used to control operation of the system. In addition to the controller 108, one or more additional computing devices may be electronically coupled to the controller 108. Thus, data, operational information, and control functions can be transmitted between the controller and the separate computing devices, as needed.

In operation, the controller 108 determines an amount of pressure to apply with the compression elements to the limb. Thus, in one embodiment, the controller 108 causes the system 100 to vary an amount of pressure applied to the limb based on a rate of blood flow desired in the limb. The pressure sensor 110 provides feedback to the controller to vary the compression of the compression material until it a predetermined pressure threshold is obtained.

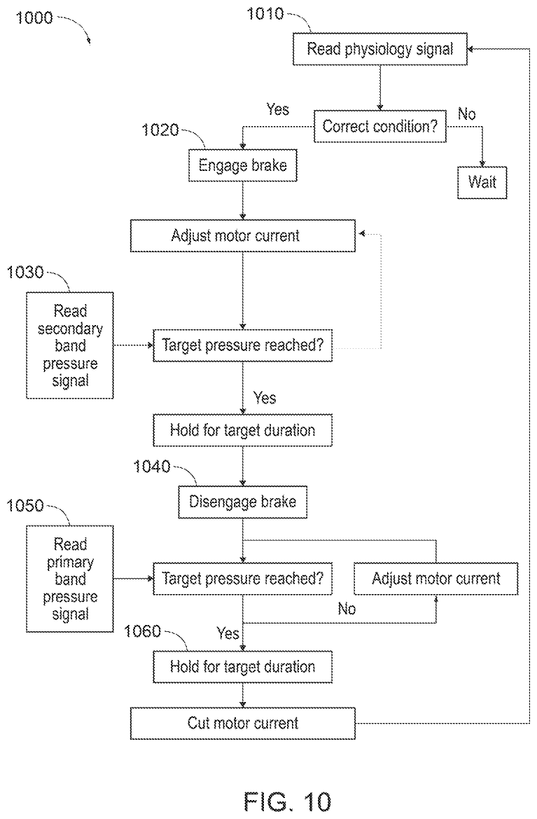

FIG. 10 shows a flowchart of an operational method of the limb compression system 100. As illustrated, the method 1000 comprises monitoring a physiological signal 1010 to determine whether to begin compression. If the physiological condition is deemed appropriate, the braking system 140 is engaged to stop the motor barrel 120 from turning and the motor torque is increased 1020, causing the second compression element 132 winding around the secondary barrel 124 to tighten. The pressure under the second compression element 132 is read to determine when the desired pressure is reached, at which point the system 100 holds for the desired time at fixed motor torque 1030. At the set time, the braking system 140 is disengaged, transferring torque to the motor barrel 120. In 1050, the pressure sensor 118 under the first compression element 128 is monitored and the motor torque is adjusted to reach the desired pressure under the first compression element 128. This is then held for the desired duration, at which point motor torque is removed (or reversed) and the system 100 resets for the next compression cycle 1060.

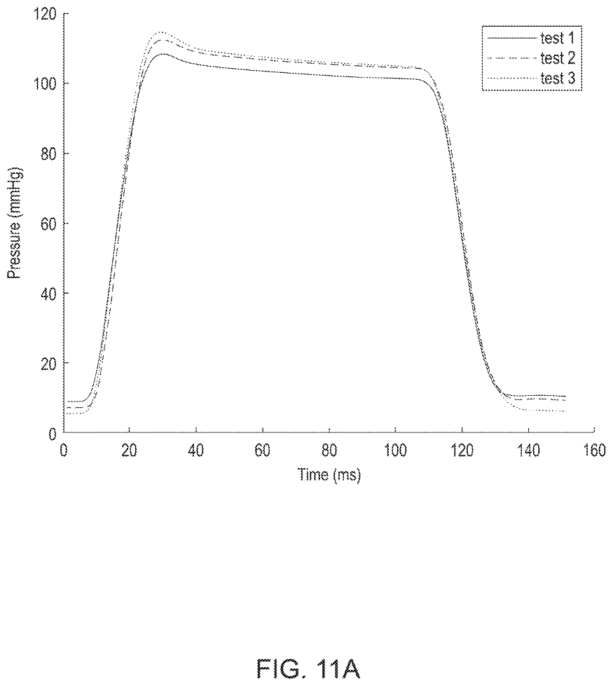

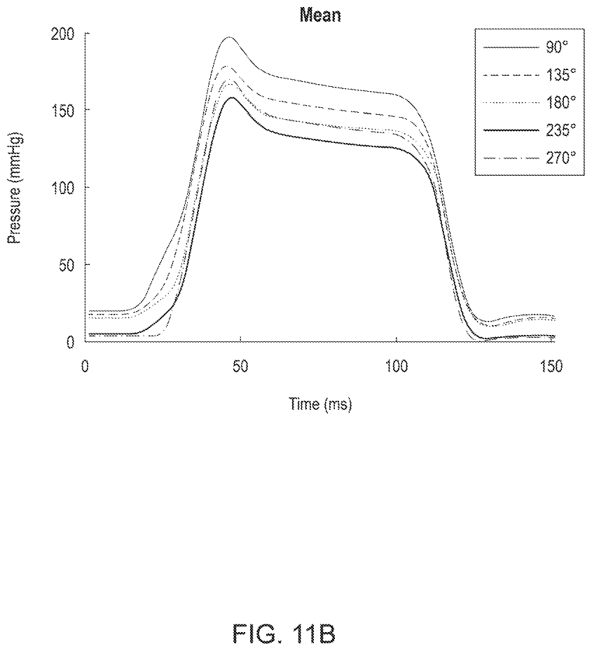

FIGS. 11A and 11B show results realized by utilizing an embodiment of the system or method disclosed herein. The results are illustrated as measured pressure as a function of time under the second compression element 132 (i.e. secondary strap). FIG. 11A shows the applied pressure over an application cycle for three separate tests. FIG. 11B shows the applied pressure at 5 different locations along the circumference of the secondary strap. The angle is measured from the line connected to the motor axis and the axis of the limb. Each line represents the mean of 5 trials.

1. A system, comprising:
an actuation module having a motor, a motor barrel couple to the motor and is rotatable about a longitudinal axis, a secondary barrel that is rotatable about the longitudinal axis, and a brake coupled to the motor barrel and the secondary barrel;
a first compression element coupled to the motor barrel and configured to apply compression to a limb when placed around the limb when the motor barrel is rotating;
a second compression element coupled to the secondary barrel and configured to apply compression to a limb when placed around the limb when the second barrel is rotating; and
a controller operably coupled to the motor and the brake, the controller configured to, in response to one or more inputs, in a first operating condition, cause the motor to rotate the motor barrel and the secondary barrel, and in a second operating condition, cause the brake to inhibit rotation of the secondary barrel while permitting the motor barrel to rotate independently of the secondary barrel.

2. A system, comprising:
a) an actuation module having:
a motor;
a shaft that extends along a longitudinal axis and is coupled to the motor, the shaft configured to rotate about the longitudinal axis in response to operation of the motor;
a motor barrel coupled to the shaft such that the motor barrel is rotatable about the longitudinal axis;
a secondary barrel coupled to the shaft such that the secondary barrel is rotatable about the longitudinal axis;
a brake coupled to the motor barrel and the secondary barrel;
b) a first compression element coupled to the motor barrel and configured to apply compression to a limb when placed around the limb;
c) a second compression element coupled to the secondary barrel and configured to apply compression to a limb when placed around the limb; and
d) a controller operably coupled to the motor and the brake, the controller configured to, in response to one or more inputs, in a first operating condition, cause the motor to rotate the motor barrel and the secondary barrel, and in a second operating condition, cause the brake to inhibit rotation of the secondary barrel while permitting the motor barrel to rotate independently of the secondary barrel.

3. A system, comprising:
an actuation module;
a first compression element coupled to the actuation module and configured to apply compression to a limb when placed around the limb;
a second compression element coupled to the actuation module and configured to apply compression to the limb when placed around the limb;
at least one sensor configured to measure pressure applied by the first and second compression elements to the limb; and
a controller operably coupled to the at least one sensor and the actuation module, the controller configured to, in response to data obtained by the at least one sensor, automatically cause the first and second compression elements to apply compression to the limb up to a predetermined threshold of pressure.

4. The system according to claim 1, further comprising a housing that carries the actuation module.

5. The system according to claim 1, wherein first compression element is a first strap coupled to the motor barrel, the first strap having a first end and a second end opposite the first end; and the second compression element is a second strap coupled to the secondary barrel, the second strap having a first end and a second end opposite the first end.

6. The system of claim 5, wherein the first strap is configured to wind around the motor barrel such that rotation of the motor barrel pulls the first end of the first strap while the second end of the first strap remains fixed and shortens the first strap around the limb.

7. The system of claim 5, wherein the first end and the second end of the first strap is coupled to the motor barrel such that rotation of the motor barrel causes the first strap to wind around the motor barrel.

8. The system according to claim 1, further comprising:
a plurality of sensors configured to measure a rate of blood flow in the limb; and
wherein the controller is communicatively coupled to the plurality of sensors such that the controller causes transition between first and second operating conditions based on measured rate of blood flow in the limb.

9. The system of claim 8, wherein the plurality of sensors include at least one physiological sensor and at least one pressure sensor.

10. system of claim 9, wherein the physiological sensor is configured to obtain data indicative of local diastole.

11. The system of claim 9, wherein the physiological sensor is a non-invasive peripheral blood flow sensor or an optical sensor.

12. The system of claim 9, wherein the pressure sensor is configured to obtain data indicative of pressure applied by the first or second compression elements to the limb.

13. The system according to claim 1, wherein the controller is further configured to, in response to data indicative of blood flow, analyze a blood flow pattern, and adjust operation of the actuation module to adjust compression applied by the compression elements to the limb.

14.-18. (canceled)

19. The system of according to claim 2, further comprising a housing that carries the Preliminary_Amendment_actuation module.

20. The system of according to claim 2, wherein first compression element is a first strap coupled to the motor barrel, the first strap having a first end and a second end opposite the first end; and the second compression element is a second strap coupled to the secondary barrel, the second strap having a first end and a second end opposite the first end.

21. The system of claim 20, wherein the first strap is configured to wind around the motor barrel such that rotation of the motor barrel pulls the first end of the first strap while the second end of the first strap remains fixed and shortens the first strap around the limb.

22. The system according to claim 2, further comprising:
a plurality of sensors configured to measure a rate of blood flow in the limb; and
wherein the controller is communicatively coupled to the plurality of sensors such that the controller causes transition between first and second operating conditions based on measured rate of blood flow in the limb.

23. The system according to claim 2, wherein the controller is further configured to, in response to data indicative of blood flow, analyze a blood flow pattern, and adjust operation of the actuation module to adjust compression applied by the compression elements to the limb.

24. The system of according to claim 3, wherein first compression element is a first strap, the first strap having a first end and a second end opposite the first end; and the second compression element is a second strap, the second strap having a first end and a second end opposite the first end.

25. The system of claim 24, wherein the first strap is configured such that pulling the first end of the first strap while the second end of the first strap remains fixed and shortens the first strap around the limb.

26. The system according to claim 3, further comprising:
a plurality of sensors configured to measure a rate of blood flow in the limb; and
wherein the controller is communicatively coupled to the plurality of sensors such that the controller causes transition between first and second operating conditions based on measured rate of blood flow in the limb.

27. The system of claim 26, wherein the pressure sensor is configured to obtain data indicative of pressure applied by the first or second compression elements to the limb.

28. The system according to claim 3, wherein the controller is further configured to, in response to data indicative of blood flow, analyze a blood flow pattern, and adjust operation of the actuation module to adjust compression applied by the compression elements to the limb.
